(19) United States
(12) Patent Application Publication
(10) Pub. No.: US 2026/0069967 A1
(43) Pub. Date: Mar. 12, 2026

(54) GAME CONTROLLER

(71) Applicant: DEXIN CORP., New Taipei City (TW)

(72) Inventors: Ho Lung LU, New Taipei City (TW); Yu-Ting LIN, New Taipei City (TW)

(73) Assignee: DEXIN CORP., New Taipei City (TW)

(21) Appl. No.: 19/388,542

(22) Filed: Nov. 13, 2025

(30) Foreign Application Priority Data
Oct. 8, 2025 (TW) 114138819

(51) Int. Cl. A63F 13/24

(52) U.S. Cl. CPC A63F 13/24

(57) ABSTRACT

A game controller configured to be connected to a game console and including a host, at least one button device and at least one expansion assembly. The host is configured to be connected to the game console. The host includes a main part and two protruding parts. The two protruding parts protrude from a side of the main part. The main part has two first assembling parts. Each of the two protruding parts have a second assembling part. The two first assembling parts are removably assembled to the two second assembling parts. The button device is disposed on the main part of the host and electrically connected to the host. The expansion assembly is removably disposed on one of the two protruding parts of the host and electrically connected to the host. The expansion assembly and the button device are located on a side of the host.

### CROSS-REFERENCE TO RELATED APPLICATIONS

This non-provisional application claims priority under 35 U.S.C. § 119(a) on Patent Application No(s). 114138819 filed in Taiwan, R.O.C. on October 8th, 2025, the entire contents of which are hereby incorporated by reference.

### TECHNICAL FIELD

The disclosure relates to a game controller, more particularly to a game controller having at least one expansion assembly.

### BACKGROUND

As the game console becomes widespread, besides the wired game controller (with a cable connected thereto), various wireless game controllers are developed to enhance the user experience by overcoming the limitation of the cables.

However, conventional game controllers have monotonous functions, thereby leading to monotonous sensory experience and poor user experience. Thus, it is important for the researchers to develop a game controller having diversified functions and thus enhanced user experience.

### SUMMARY

The disclosure provides a game controller having diversified functions and thus enhanced user experience.

One embodiment of this disclosure provides a game controller configured to be connected to a game console and including a host, at least one button device and at least one expansion assembly. The host is configured to be connected to the game console. The host includes a main part and two protruding parts. The two protruding parts protrude from a side of the main part. The main part has two first assembling parts. Each of the two protruding parts have a second assembling part. The two first assembling parts are removably assembled to the two second assembling parts. The at least one button device is disposed on the main part of the host and electrically connected to the host. The at least one expansion assembly is removably disposed on one of the two protruding parts of the host and electrically connected to the host. The at least one expansion assembly and the at least one button device are located on a side of the host.

According to the game controller discussed by above embodiments, since at least one of various types of expansion assemblies is allowed to be additionally disposed on the host of the game controller, the functions of the game controller are diversified and thus the user experience of the game controller is enhanced.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a game controller according to one embodiment of the disclosure;

FIG. 2 is a rear view of the game controller in FIG. 1;

FIG. 3 is an exploded view of the game controller in FIG. 1; and

FIG. 4 is another exploded view of the game controller in FIG. 1

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

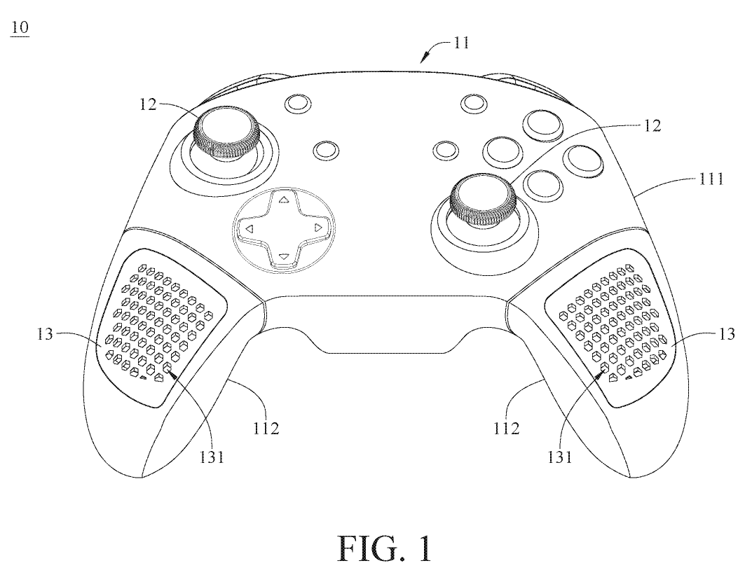

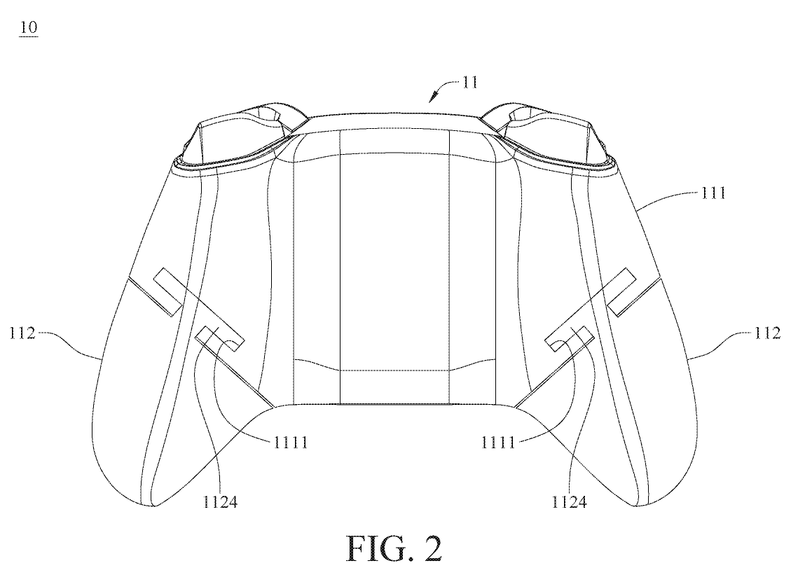

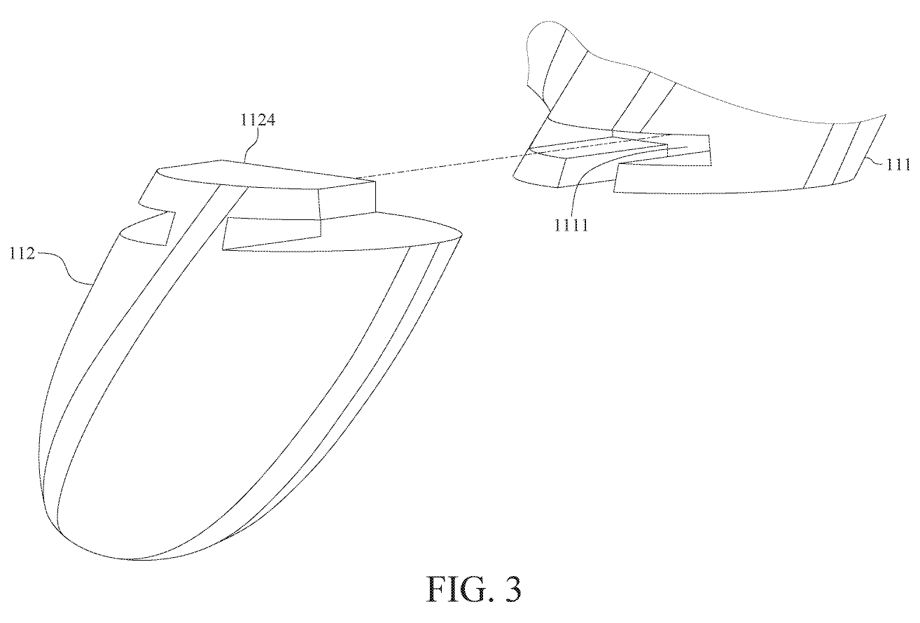

Please refer to FIGS. 1 to 3. FIG. 1 is a perspective view of a game controller 10 according to one embodiment of the disclosure. FIG. 2 is a rear view of the game controller 10 in FIG. 1. FIG. 3 is an exploded view of the game controller 10 in FIG. 1. The game controller 10 is configured to be connected to a game console (not shown)。

The game controller 10 includes a host 11, a plurality of button devices 12 and two expansion assemblies 13. The host 11 is configured to be connected to the game console.

The host 11 includes a main part 111 and two protruding parts 112. The two protruding parts 112 protrude from the same side of the main part 111. The main part 111 has two first assembling parts 1111. Each protruding part 112 has a second assembling part 1124. For example, the first assembling parts 1111 and the second assembling parts 1124 are dovetail recesses and dovetail protrusions matching each other, respectively, and the two first assembling parts 1111 are removably assembled to the two second assembling parts 1124, respectively.

The button devices 12 are disposed on the main part 111 of the host 11 and electrically connected to the host 11. Button caps of the button devices 12 may be movably disposed on the main part 111. In general, a surface of the main part 111 where the button devices 12 are disposed may be regarded as a front surface of the main part 111, and the front surface faces toward, for example, the user of the game controller 10. The button devices 12 are configured to be pressed to control, for example, the movement of the character in the game. That is, the button devices 12 may be directional pads. Further, there may be other types of button devices disposed on the main part 111 of the host 11 to control the character in the game in other manners.

The two expansion assemblies 13 and the button devices 12 are located on the same side of the host 11. That is, the two expansion assemblies 13 and the button devices 12 are located on the front surface of the host 11.

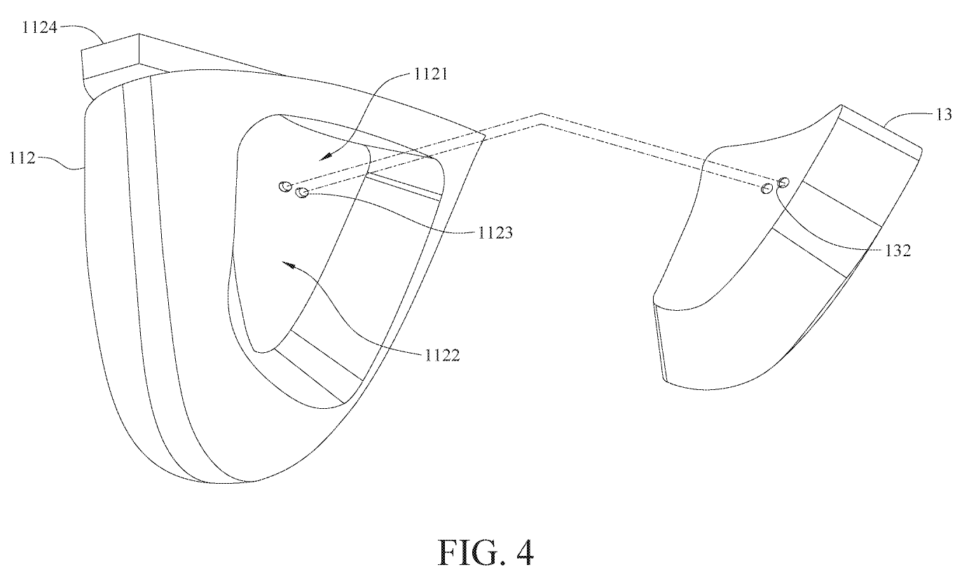

Please refer to FIG. 4. FIG. 4 is another exploded view of the game controller 10 in FIG. 1. For example, the two expansion assemblies 13 are fans, and are removably disposed on the two protruding parts 112 of the host 11, respectively. The two expansion assemblies 13 are electrically connected to the host 11 so that the power may be applied from the host 11 to the two expansion assemblies 13. Since the two protruding parts 112 are respectively connected to the two expansion assemblies 13 in similar manners, only one protruding part 112 and one expansion assembly 13 corresponding to each other will be described in detail hereinafter.

The protruding part 112 has an assembling recess 1121 and a bottom surface 1122 located on the bottom of the assembling recess 1121. The expansion assembly 13 is removably disposed in the assembling recess 1121 via, for example, tight fit. The expansion assemblies 13 has an outlet 131 located on a side thereof located away from the bottom surface 1122.

The protruding part 112 has a first connector 1123 located on the bottom surface 1122. The expansion assembly 13 has a second connector 132. The first connector 1123 and the second connector 132 are, for example, pogo pin connectors. The first connector 1123 is electrically connected to the second connector 132.

In this embodiment, the expansion assemblies 13 are respectively disposed on the protruding parts 112 of the host 11 via tight fit, but the disclosure is not limited thereto. In other embodiments, the expansion assemblies may be respectively disposed on the protruding parts of the host by magnetic attraction.

In this embodiment, the expansion assemblies 13 are fans, but the disclosure is not limited thereto. In other embodiments, the expansion assemblies may be aroma diffusers, vibrators or biosensors.

When the expansion assembly is an aroma diffuser providing a variety of scents. The scents may include floral, herbal, and other types of aromas. Because the scents can evoke human memories and emotional responses related to real environments, the scents enhance the sense of presence. Therefore, by providing multiple scents, users experience not only visual and auditory sensations during gameplay but also olfactory stimulation, which creates a multisensory immersive experience and thus enhances the overall user experience of the game controller.

When the expansion assembly is a vibrator, the expansion assembly provides vibration-based tactile feedback, allowing users to experience physical sensations that correspond to on-screen actions or in-game scenarios during gameplay. For example, when collisions, explosions, or impacts are simulated in the game, the vibrations can instantly deliver realistic tactile sensations, which enables users to engage not only through visual and auditory inputs but also through the sense of touch. Such a multisensory interactive function enhances the user’s sense of immersion, thereby enhancing the overall user experience of the game controller.

When the expansion assembly is a biosensor, the expansion assembly may be disposed on the protruding part of the host and configured to generate biological data.

Since the expansion assemblies may be fans, aroma diffusers, vibrators or biosensors, the user may exchange different types of expansion assemblies according to actual requirements, thereby enhancing the overall user experience of the game controller.

According to the game controller discussed by above embodiments, since at least one of various types of expansion assemblies is allowed to be additionally disposed on the host of the game controller, the functions of the game controller are diversified and thus the user experience of the game controller is enhanced.

Specifically, when the expansion assembly is a fan, the airflow generated by the expansion assembly can improve ventilation, which solves the issue of sweaty hands that occurs when users play with the game controller for a long time, thereby enhancing the user experience of the game controller. The expansion assembly may be an aroma diffuser providing various scents to enhance olfactory stimulation and further improve the user experience of the game controller. Furthermore, the expansion assembly may be a vibrator providing tactile feedback through vibration. In this way, the functions of the game controller can be diversified, thereby enhancing the user experience of the game controller.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A game controller, configured to be connected to a game console and comprising:
a host, configured to be connected to the game console, wherein the host comprises a main part and two protruding parts, the two protruding parts protrude from a side of the main part, the main part has two first assembling parts, each of the two protruding parts have a second assembling part, and the two first assembling parts are removably assembled to the two second assembling parts;
at least one button device, disposed on the main part of the host and electrically connected to the host; and
at least one expansion assembly, removably disposed on one of the two protruding parts of the host and electrically connected to the host;
wherein, the at least one expansion assembly and the at least one button device are located on a side of the host.

2. The game controller according to claim 1, wherein the two first assembling parts and the two second assembling parts are dovetail recesses and dovetail protrusions matching each other, respectively.

3. The game controller according to claim 1, wherein the at least one expansion assembly is an aroma diffuser and configured to provide at least one scent.

4. The game controller according to claim 1, wherein the at least one expansion assembly is a vibrator.

5. The game controller according to claim 1, wherein the at least one expansion assembly is a biosensor disposed on one of the two protruding parts of the host and configured to generate biological data.

6. The game controller according to claim 1, wherein the at least one expansion assembly is removably disposed on one of the two protruding parts of the host via tight fit.

7. The game controller according to claim 1, wherein one of the two protruding parts has an assembling recess and a bottom surface located on a bottom of the assembling recess, the at least one expansion assembly is removably disposed in the assembling recess, the at least one expansion assembly is a fan, and the at least one expansion assembly has an outlet located on a side thereof located away from the bottom surface.

8. The game controller according to claim 7, wherein one of the two protruding parts has a first connector located on the bottom surface, the at least one expansion assembly has a second connector, and the first connector is electrically connected to the second connector.

9. The game controller according to claim 8, wherein the first connector and the second connector are pogo pin connectors.

10. The game controller according to claim 1, wherein the at least one button device is a directional pad.
